(19) United States
(12) Patent Application Publication
(10) Pub. No.: US 2014/0346950 A1
(43) Pub. Date: Nov. 27, 2014

(54) COMPACT DISCHARGE LAMP

(71) Applicants: Seong Jin Kang, Seoul (KR); Seong Seok Kang, Seoul (KR)

(72) Inventors: Seong Jin Kang, Seoul (KR); Seong Seok Kang, Seoul (KR)

(21) Appl. No.: 14/456,073

(22) Filed: Aug. 11, 2014

Related U.S. Application Data
(63) Continuation of application No. PCT/KR2013/001064, filed on Feb. 12, 2013.

(30) Foreign Application Priority Data
Feb. 10, 2012 (KR) 10-2012-0013782

(51) Int. Cl. H01J 61/52; H01J 61/34; H01J 61/56; H01J 61/32

(52) U.S. Cl. CPC H01J 61/523; H01J 61/327; H01J 61/34; H01J 61/56
USPC 315/50

(57) ABSTRACT

Disclosed is a compact discharge lamp capable of preventing the heat from a discharge tube from damaging circuit elements of a stabilizer. The compact discharge lamp includes: the discharge tube having a structure that provides a stabilizer-accommodating space at the center thereof and including an electrode; a bulb base coupled to an end portion of the stabilizer housing; a stabilizer printed circuit board that is accommodated in the stabilizer housing and is provided with stabilizer circuit elements configured to initiate a discharge by being supplied with electric power from the bulb base and by supplying the electric power to the electrode; and a connection space-forming unit that provides a separate connection space near a circumferential surface of the stabilizer housing in order to electrically connect a stabilizer electric power line extending from the stabilizer printed circuit board with the electrode.

### REFERENCE TO RELATED APPLICATIONS

This is a continuation of pending International Patent Application PCT/KR2013/001064 filed on Feb. 12, 2013, which designates the United States and claims priority of Korean Patent Application No. 10-2012-0013782 filed on Feb. 10, 2012, the entire contents of which are incorporated herein by reference.

### FIELD OF THE INVENTION

The present invention relates to a discharge lamp that can protect heat-vulnerable circuit elements among the stabilizer circuit elements from the heat of a high temperature radiating from a discharge tube.

### BACKGROUND OF THE INVENTION

A discharge lamp is widely used for a variety of lighting equipment. In general, a discharge lamp includes a discharge tube made of a transparent material such as glass or quartz, and a stabilizer for driving the discharge lamp. In the discharge tube, a discharge gas such as mercury vapor, a buffer gas, or the like is sealed. Accordingly, when power is externally supplied to the discharge tube through the stabilizer, a discharge occurs in the discharge tube due to the discharge gas, thereby creating plasma which causes UV rays, visible rays, or the like to be emitted. A fluorescent lamp is a type of discharge lamp and is configured in the following manner: a fluorescent material is coated on the inner surface of a discharge tube and UV rays generated by the plasma cause the fluorescent material to emit visible rays so that the visible rays are emitted from the discharge tube.

Presently, various types of discharge lamps are being suggested. Especially a bulb-type discharge lamp illustrated in FIGS. 1 and 2, which is inserted into a socked when it is used, is being widely used. The discharge lamp illustrated in FIGS. 1 and 2 includes a stabilizer hosing 2 in which a stabilizer printed circuit board 4 is accommodated, and a bulb base 3 to be inserted into a bulb sock. The stabilizer housing 2 is mechanically coupled to a discharge tube 1 and is also electrically connected to the discharge tube 1 to supply electric power to the discharge tube 1.

However, since this type of discharge lamp is configured such that the discharge tube 1, the stabilizer housing 2, and the bulb base 2 are coupled in line, the length of the discharge lamp is considerably long compared to general incandescent lamps so that it cannot be applied to existing lighting equipment that use general incandescent lamps.

Moreover, since the structure of the discharge does not take into consideration the thermal isolation between the discharge tube 1 and the stabilizer housing 2, the heat of a high temperature radiating from an electrode 1a of the discharge tube 1 is fully transferred to all over the bottom surface of the printed circuit board 4 of the stabilizer in the view of FIG. 2, and thus the inside temperature of the stabilizer housing 2 increases, which is accompanied by an increase in the temperature of various circuit elements incorporated in the stabilizer printed circuit board 4. This may lead to break down or fusing-out of the circuit elements.

Accordingly, there has been a high demand for a discharge lamp that is capable of protecting stabilizer circuit elements from the heat of a high temperature radiating from the discharge tube 1.

### SUMMARY OF THE INVENTION

Accordingly, the present invention has been made keeping in mind the above problems occurring in the related art, and the present invention is intended to propose a discharge lamp that is capable of protecting circuit elements of a stabilizer from the heat from a discharge tube.

In order to achieve the above object, according to an aspect of the present invention, there is provided a compact discharge lamp including: a discharge tube at the center of which there is a stabilizer-accommodating space, the discharge tube being provided with an electrode to which electric power is supplied; a stabilizer housing disposed in the stabilizer-accommodating space; a bulb base coupled to an end portion of the stabilizer housing; a stabilizer printed circuit board accommodated in the stabilizer housing and provided with stabilizer circuit elements that initiate a discharge by being supplied with the electric power from the bulb base and supplying electric power to the electrode and that performs driving such that the initiated discharge is maintained; and a connection space-forming unit configured to provide a separate connection space outside the stabilizer housing so that a stabilizer electric power line extending from the stabilizer printed circuit board is electrically connected with the electrode therein.

The connection space-forming unit may include a discharge tube supporting space in which a portion of the discharge tube, the portion being on an electrode side, is accommodated, and a discharge tube holder which allows the connection space to communicate with the discharge tube supporting space, and the connection space-forming unit may support the discharge tube.

The discharge tube holder may include: a holder body having the discharge tube supporting space and the connection space and further having an opening that communicates with the connection space; and a cover coupled to the holder body so as to close the opening.

The stabilizer housing may include a first housing and a second housing that are coupled to each other so as to provide a space to accommodate the stabilizer printed circuit board therein, in which the first housing and the second housing correspond to one side and the other side of the stabilizer housing, respectively, when separated.

Either one of the first housing and the second housing may be provided with either the holder body or the cover.

The stabilizer electric power line may be led outside the stabilizer housing through a gap between the first housing and the second housing and then be introduced into the connection space through a coupling gap between the holder body and the cover.

Either the first housing or the second housing may include an insertion portion which is inserted into the other housing out of the first housing and the second housing so that the first housing may overlap the second housing, and the stabilizer electric power line lead outside the stabilizer housing may be pressed and inserted in the overlapping portion of the first housing and the second housing.

The stabilizer housing and the bulb base may be arranged in line, the connection space-forming unit may be arranged closer to a bulb base side of the stabilizer housing, out of the bulb base side, which is one end side of the stabilizer housing, and the opposite side, which is the other end side of the stabilizer housing, the stabilizer printed circuit board may be arranged in a direction in which the stabilizer housing and the bulb base are arranged, and heat-vulnerable elements out of the stabilizer circuit elements may be arranged at a position farthest from the bulb base on the stabilizer printed circuit board.

The heat-vulnerable elements may be a semiconductor element or an electrolyte capacitor, and the semiconductor element may be a transistor, a field effect transistor, or a control IC.

Less heat-sensitive elements out of the stabilizer circuit elements may be arranged at a position near the bulb base on the stabilizer printed circuit board.

According to another aspect of the invention, there is provided a discharge lamp including: a discharge tube equipped with an electrode to be supplied with electric power; a stabilizer housing; and a bulb base coupled to an end portion of the stabilizer housing; a stabilizer printed circuit board that is accommodated in the stabilizer housing and is provided with stabilizer circuit elements configured to initiate a discharge by being supplied with electric power from the bulb base and by supplying electric power to the electrode and configured to perform driving such that the initiated discharge is maintained, in which, between a bulb base side and the opposite side, the electrode is arranged closer to the bulb base side than the opposite side, and in which heat-vulnerable circuit elements out of the stabilizer circuit elements are arranged at a position farthest from the bulb base on the stabilizer printed circuit board.

According to the invention, circuit elements of a stabilizer and electrodes of a discharge tube are provided in separate spaces, respectively so as to be thermally isolated from each other. Moreover, heat-vulnerable parts out of the circuit elements of the stabilizer are arranged at a relatively longer distance from the electrode of the discharge tube. For such a reason, the heat from the discharge tube can be prevented from damaging the stabilizer, which would prevent a decrease in the life span of the stabilizer. That is, it is possible to extend the expected life span of the stabilizer.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a front view illustrating a discharge lamp according to a related art;

FIG. 2 is a cross-sectional view illustrating a discharge lamp according to the related art;

FIG. 3 is a front view illustrating a compact discharge lamp according to a first embodiment of the invention;

FIG. 4 is a cross-sectional view illustrating the compact discharge lamp according to the first embodiment;

FIG. 5 is an enlarged view illustrating a portion A of FIG. 4;

FIG. 6 is a diagram illustrating a usage state in which the compact discharge lamp according to the first embodiment is employed in ceiling-embedded type lighting equipment; and

FIG. 7 is a cross-sectional view illustrating a compact discharge lamp according to a second embodiment of the invention.

### DETAILED DESCRIPTION OF THE INVENTION

Hereinbelow, a compact discharge lamp according to preferred embodiments of the present invention will be described in detail with reference to the accompanying drawings. However, it should be understood that the embodiment of the present invention may be changed to a variety of embodiments and the scope and spirit of the present invention are not limited to the embodiment described hereinbelow. The embodiments of the present invention described hereinbelow are provided for allowing those skilled in the art to more clearly and fully comprehend the present invention.

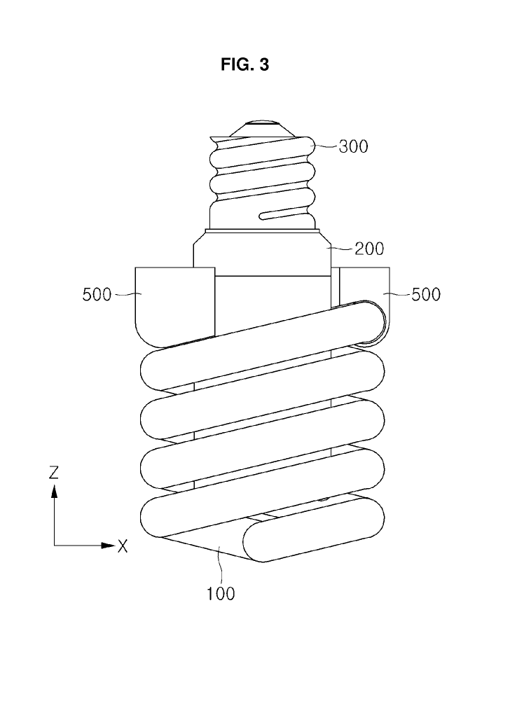

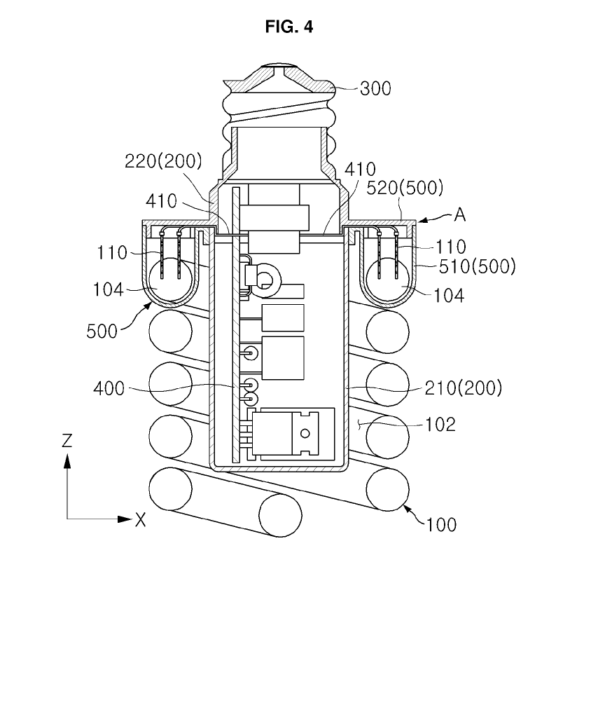

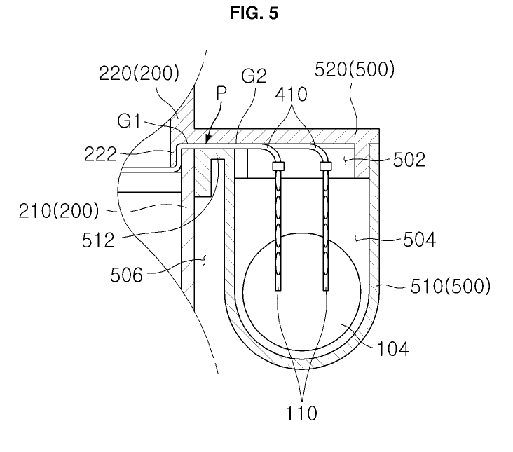

FIGS. 3 and 4 are a front view and a cross-sectional view showing a compact discharge lamp according to a first embodiment of the invention. FIG. 5 is an enlarged view illustrating a portion denoted by A in FIG. 4. In FIGS. 3 to 5, a discharge tube 100 and a stabilizer housing 200 are shown.

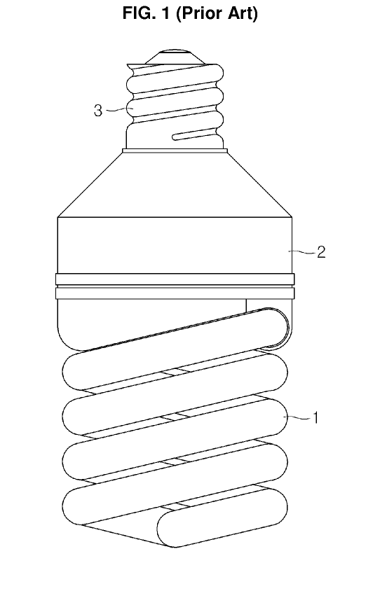

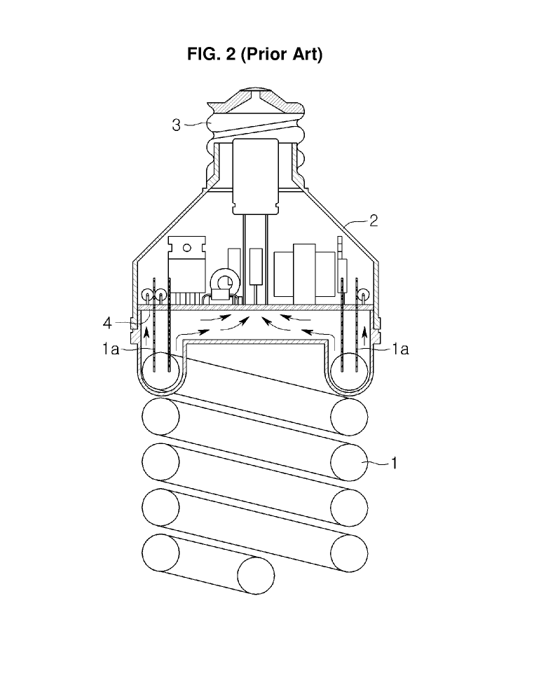

As illustrated in FIGS. 3 and 4, the overall structure of the discharge tube 100 is spiral in shape. That is, along the longitudinal direction (Z-axis direction) of the compact discharge lamp, the discharge tube 100 spirally winds to provide a stabilizer-accommodating space 102 at the center thereof. The stabilizer housing 200 can be inserted into and arranged in the stabilizer-accommodating space 102. According to the first embodiment, the total length of the discharge lamp is determined by the size of the discharge tube 100 in the Z-axis direction and the size of a bulb base 300, in the Z-axis direction, coupled to an upper portion of the stabilizer housing 200 in the view of FIG. 3. Compared to a discharge lamp (refer to FIGS. 1 and 2) according to the related art in which a bulb base, a stabilizer housing, and a discharge tube are coupled in line in this order, the lamp according to the first embodiment can be manufactured to be relatively compact.

The discharge tube 100 is configured by a tube made of a transparent material or by a plurality of tubes made of a transparent material and connected to each other so as to communicate with each other. Referring to FIGS. 4 and 5, the discharge tube 100 is provided with two pairs of electrodes 110 to which electric power is supplied. A portion of the discharge tube 100 in which the electrodes 110 are provided may be hermetically sealed. The electrodes 110 are arranged on an upper end portion of the discharge tube 100 in the view of FIG. 4. The pair of electrodes 110 arranged in the manner described above and the other pair of electrodes 110 may be arranged to face each other with the stabilizer-accommodating space 102 interposed therebetween.

The stabilizer housing 200 inserted in the stabilizer-accommodating space 102 is configured to elongate in the Z-axis. As illustrated in FIGS. 3 to 5, a stabilizer printed circuit board 400 that is supplied with electric power from the bulb base 300 and supplies the electric power to the electrodes 110 is accommodated in the stabilizer housing 200 to be arranged in the Z-axis direction. A discharge tube holder 500 is provided around the circumferential surface of the stabilizer housing 200. The discharge tube holder 500 supports an electrode-installed portion 104 of the discharge tube, in which the two pairs of electrodes 110 are installed. In addition, the discharge tube holder 500 provides a separate connection space 502 in which a stabilizer electric power line 410 extending from the stabilizer printed circuit board 400 is connected to the electrodes 110. The connection space 502 is provided to thermally isolate the electrodes 110 from the stabilizer printed circuit board 400 so that “circuit elements functioning as a stabilizer” (hereinafter referred to as “stabilizer circuit elements”) on the stabilizer printed circuit board 400 are prevented from being damaged by the heat from the electrodes 110.

The stabilizer housing 200 is configured by a first housing 210 located in the stabilizer-accommodating space 102 and a second housing 220 partially exposed from an upper end of the stabilizer-accommodating space 102 in the view of FIG. 4. In the direction shown in FIG. 4, the structure of the first housing 210 is such that an upper end portion of the first housing 210 is open. The structure of the second housing 220 is such that an upper end portion of the second housing 220 is coupled to the bulb base 300 and a lower end portion of the second housing 200 is open. The first housing 210 and the second housing 220 are coupled such that the upper end portion of the first housing 210 is coupled to the lower end portion of the second housing 220. When the first housing 210 and the second housing 220 are coupled, an isolated space is provided inside the stabilizer housing 200 so that the stabilizer printed circuit board 400 can be accommodated therein. The first housing 210 is longer than the second housing 220 in the Z-axis direction so that most of the space for accommodating the stabilizer printed circuit board 400 is provided by the first housing 210.

As illustrated in FIG. 4, either the upper end of the first housing 210 or the lower end of the second housing 220 is provided with an insertion portion 220 so that this insertion portion 220 is inserted into a portion of the other housing. The insertion portion 220 is formed to be provided along the circumferential direction of the first housing 210 or the second housing 220. The first housing 210 and the second housing 220 are coupled in an inserting manner, and the upper end portion of the first housing 210 overlaps the lower end portion of the second housing 220 in a coupled state.

Referring to FIGS. 4 and 5, the stabilizer electric power line 410 extends from the inside of the stabilizer housing 200 to the outside through a coupling gap G1 formed at a coupling portion between the first housing 210 and the second housing 220 so that it is connected to the respective electrodes 110 in the connection space 502. In this case, the stabilizer electric power line 410 is pressed at and inserted in the overlapping portion of the first housing 210 and the second housing 220.

The discharge tube holder 500, which also functions as a connection space-forming unit, has the connection space 502 and a discharge tube supporting space 504 that accommodates an electrode-installed portion 104 of the discharge tube 100. As illustrated in FIGS. 4 and 5, the discharge tube holder 500 includes a holder body 510, the top of which is open, a shielding cover 502 that is coupled to the top of the holder body 510 so as to cover the open top portion of the holder body 510.

In the holder body 510, the open top portion communicates with the discharge tube supporting space 504 and the discharge tube supporting space 504 communicates with the connection space 502. The electrode-installed portion 104 passes through a through hole formed in the holder body 510 and is accommodated in the discharge tube supporting space 504. A portion of the holder body 510, through which the electrode installation portion 104 passes, may be sealed.

As illustrated in FIGS. 4 and 5, the stabilizer electric power line 410 extending up to the outside from the stabilizer housing 300 is introduced into the connection space 502 through the coupling gap G2 formed between the holder body 510 and the shielding cover 520.

As illustrated in FIG. 5, the holder body 510 and the shielding cover 520 are arranged to have a drawing position P of the stabilizer electric power line 410 therebetween. The holder body 510 is distanced from the first housing 210 in the X-axis direction. The shielding cover 520 is integrally formed with the second housing 220. The shielding cover 520 includes a cover portion that covers the open top portion of the holder body 510 and a connection portion that connects the cover portion to the second housing 220. Either the first housing 210 or the holder body 510 is provided with an electric power line protecting cover 512 that covers and protects the stabilizer electric power line 410 at a position between the first housing 210 and the holder body 510 along with the connection portion of the shielding cover 520.

On the other hand, depending on implementation conditions, the holder body 510 may be integrally formed with the first housing 210 and the shielding cover 520 may be detachably coupled to the second housing 220. The electric power line protecting cover 512 may be integrally formed with either the first housing 210 or the holder body 510.

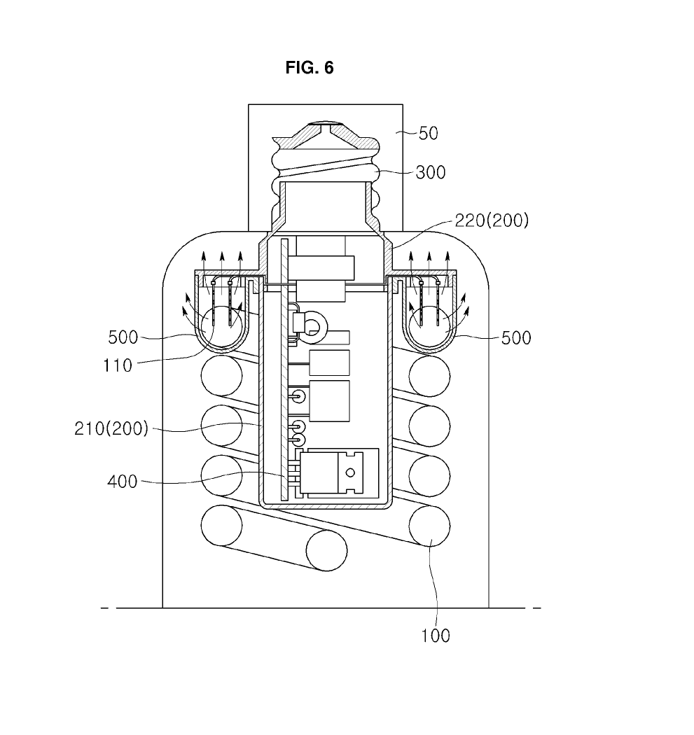

FIG. 6 is a diagram illustrating a usage state of the compact discharge lamp according to the first embodiment. As illustrated in FIG. 6, the first embodiment may apply to lighting equipment embedded in ceiling. In FIG. 6, a bulb socket 50 is illustrated. In the bulb socket 50 for ceiling-embedded type lighting equipment, the bulb base 300 according to the first embodiment is inserted. According to the first embodiment, when electric power is supplied to the electrodes 110 of the discharge tube 100 through the stabilizer printed circuit board 400, the discharge is initiated and then maintained.

In the first embodiment, when the discharge lamp is operated, the heat of a high temperature is generated from the two pairs of electrodes 110. In the stabilizer housing 200, the inside space (the space accommodating the stabilizer printed circuit board 400) is spatially separated from the connection space 502. Accordingly, the heat from the electrodes 110 of the discharge tube 100 is discharged to around the discharge tube holder 500, rather than being transferred to the stabilizer printed circuit board 400 accommodated in the stabilizer housing 200.

The stabilizer electric power line 410 goes to the outside through the coupling gap G1 between the first housing 210 and the second housing 220, then is introduced into the connection space 502 through the coupling gap G2 between the holder body 510 and the shielding cover 520, and finally connected to the electrodes 110. Accordingly, the stabilizer electric power line 410 extends along a long path by passing the overlapping portion of the first housing 210 and the second housing 220 at which the insertion portion 222 is provided, and is naturally bent due to such a structure when it is led outside. For such a reason, there are no communication paths between the inside space of the stabilizer housing 220 and the connection space 502 except for a passage provided for the insertion of the stabilizer electric power line 410 between the inside space of the stabilizer housing 200 and the connection space 502. Accordingly, heat is effectively prevented from being transferred from the connection space 502 to the stabilizer printed circuit board 400.

The heat of a high temperature around the discharge tube holder 500 may naturally migrate upward to the bulb base 300 due to the difference in temperature between the heat and the ground. Since the discharge tube holder 500 is on the side of the stabilizer housing 200 in the X-axis direction, the heat radiated from the connection space 502 rises up, rather than being transferred toward the stabilizer printed circuit board 400. Moreover, since the discharge tube holder 500 is separated from the stabilizer housing 200 in the X-axis direction, an air layer as a heat insulating space 506 is provided between the stabilizer housing 200 and the discharge tube holder 500. This also suppresses the heat transfer from the connection space 502 to the stabilizer printed circuit board 400.

Circuit elements are provided in the stabilizer printed circuit board 400 and function as a stabilizer. In order to effectively prevent the circuit elements serving as a stabilizer from being damaged by the heat, heat-vulnerable elements out of the stabilizer circuit elements, for example, an electrolytic capacitor, a semiconductor element, or the like are arranged at a position far from the electrodes 110. In this case, at the position farthest from the electrodes 110, the connection space 502 in which the electrodes 110 are accommodated is arranged relatively near the bulb base 300. That is, the connection space 502 may be on the lowest side of the stabilizer printed circuit board 400 in the view of FIG. 4. Examples of the semiconductor elements may include a field effect transistor (FET), a control integrated circuit (IC), and the like. According to this embodiment, it is possible to effectively prevent a rise in temperature of relatively heat-vulnerable circuit elements of a stabilizer, thereby preventing deterioration of the circuit elements, which results in an extension of the expected life span of the stabilizer.

On the other hand, less heat-vulnerable circuit elements of the stabilizer (circuit elements having relatively high heat resistance), for example, a choke transmitter, a resister, a ceramic capacitor, and a positive temperature coefficient (PTC) element are arranged near a bulb 110 or the bulb base 300 that is arranged on the top side of the stabilizer printed circuit board 400 in the view of FIG. 4.

In the case of an electrolyte capacitor, the characteristics of which are maintained by an electrolyte sealed in an aluminum casing, when the temperature rises by 10° C., it is reported that the life span of the electrolyte capacitor is shortened by half. The semiconductor elements such as a transistor serving as a switching element, a field effect transistor, and a control IC tend to malfunction or break at a predetermined temperature or higher. The instantaneous power failure or an abrupt change in voltage especially at a high temperature causes electrolyte capacitors or switching elements to instantaneously malfunction, and hence to finally break down.

According to experiments conducted by the present inventors, when the ambient temperature was 25° C., a discharge lamp (refer to FIGS. 1 and 2) of the related art had been operated for an hour and then the temperature of a stabilizer was measured. Of the measured temperatures of portions of the stabilizer, the lowest temperature was 60° C., and the temperature of the electrode side was higher than 80° C. The discharge lamp was applied to the ceiling-embedded type lighting equipment (refer to FIG. 6), and the temperature of the stabilizer was measured under the same conditions. As a result, the lowest measured temperature of the stabilizer was 85° C. to 90° C., the temperature of the transistor was 110° C. to 120° C., the temperature of the electrolyte capacitor was higher than 100° C., and the temperature of the electrode side was higher than 125° C.

According to the first embodiment, as to the stabilizer, the space to accommodate the stabilizer printed circuit board 400 and the connection space 502 are effectively thermally isolated from each other. Accordingly, when an ambient temperature was 25° C., out of the temperatures measured at a plurality of portions of the stabilizer, the lowest temperature of the stabilizer (the temperature measured at the bottom of the stabilizer printed circuit board 400 in the view of FIG. 4) was maintained at 40° C. to 50° C., and the highest temperature of the stabilizer (the temperature measured at the top of the stabilizer printed circuit board 400 in the view of FIG. 4) did not exceed 60° C. The discharge lamp according to the first embodiment was applied to the ceiling-embedded type lighting equipment (refer to FIG. 6), and the temperature was measured under the same conditions. The measurements showed that the lowest temperature was 60° C. to 70° C., the temperature of the transistor was maintained at 90° C. to 100° C., and the temperature of the electrolyte capacitor stayed at 80° C. to 90° C. For reference, when the discharge lamp was applied to the ceiling-embedded lighting equipment, the bottom side of the stabilizer printed circuit board 400 is inevitably affected by the ambient temperature unlike the opposite side, that is, the top side (toward which the heat rises and on which the heat is concentrated) of the stabilizer printed circuit board 400. Depending on the ambient temperature, the lowest temperature of the stabilizer can be lowered further.

As described above, according to the first embodiment: the space to accommodate the stabilizer printed circuit board 400 and the connection space 502 are thermally isolated from each other; a semiconductor element such as a transistor, a field effect transistor, and a control IC, or an electrolyte capacitor is arranged at a position farthest from the electrodes 110; and relatively less temperature-sensitive elements such as a choke transmitter are arranged at positions near the electrodes 110. Accordingly, semiconductor elements and electrolyte capacitors which are relatively heat vulnerable are successfully maintained at a low temperature. For such a reason, even when the instantaneous power failure or an abrupt change in voltage occurs, circuits can safely operate even without an additional protection circuit, and thus the expected life span of the stabilizer can be doubled.

On the other hand, the discharge lamp 100 may be filled with mercury vapor along with an inert gas such as argon or krypton. Amalgam which is an alloy of mercury and a metal may be further added thereto. Moreover, the inside surface of the discharge tube 100 may be coated with a fluorescent film and/or a protection film such as an alumina film.

The stabilizer housing 200 may be formed of a heat insulating material for the purpose of insulating its inside from heat. Moreover, the outside surface of the stabilizer housing 200 may be provided with a reflective layer such as a silver nitride layer, an aluminum layer, or a nickel layer so that heat can be reflected.

As the bulb base 300, a spiral base generally called Edison's base, a bi-pin cap with two protruding pins, or the like can be used.

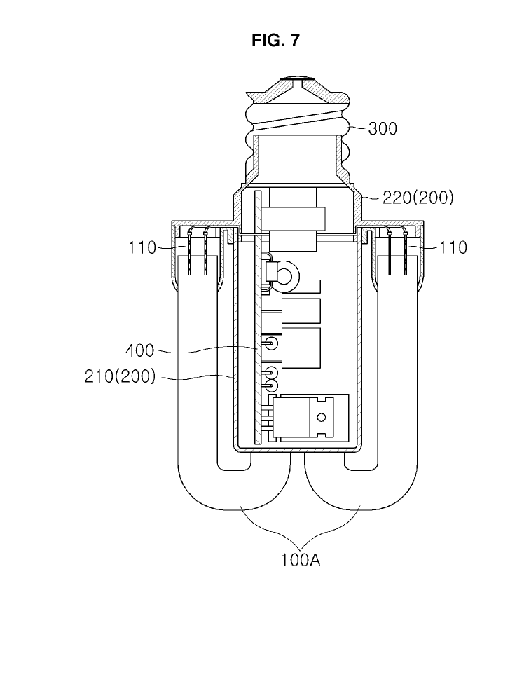

FIG. 7 is a cross-sectional view illustrating a compact discharge lamp according to a second embodiment. As illustrated in FIG. 7, the second embodiment is the same as the first embodiment in terms of structure and operation except that a plurality of U-shaped discharge tubes 100A is used instead of the spiral discharge tube (refer to reference numeral 100 in FIGS. 3 and 4). In the second embodiment, the plurality of U-shaped discharge tubes 100A is arranged to form a circular column with a stabilizer-accommodating space (refer to reference numeral 102 of FIG. 4) at the center.

Although the preferred embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A compact discharge lamp comprising:
a discharge tube that has a structure providing a stabilizer-accommodating space at the center thereof and that includes an electrode to be supplied with electric power;
a stabilizer housing arranged in the stabilizer-accommodating space;
a bulb base coupled to an end portion of the stabilizer housing;
a stabilizer printed circuit board that is accommodated in the stabilizer housing and that includes stabilizer circuit elements configured to initiate a discharge by being supplied with electric power from the bulb base and by supplying electric power to the electrodes, and configured to perform driving such that the initiated discharge is maintained; and
a connection space-forming unit that provides a connection space outside the stabilizer housing and near a circumferential surface of the stabilizer housing so that a stabilizer electric power line extending from the stabilizer printed circuit board is electrically connected with the electrodes therein.

2. The compact discharge lamp according to claim 1,
wherein the connection space-forming unit includes a discharge tube supporting space to accommodate a portion of the discharge tube, the portion being near the electrode, and a discharge tube holder through which the connection space communicates with the discharge tube supporting space.

3. The compact discharge lamp according to claim 2,
wherein the discharge tube holder includes: a holder body having the discharge tube supporting space and the connection space therein, and an opening communicating with the connection space; and a cover coupled to the holder body so as to close the opening,
wherein the stabilizer housing includes a first housing and a second housing that are coupled to each other so as to provide a space to accommodate the stabilizer printed circuit board therein and that form one side and the other side of the stabilizer housing when the first housing and the second housing are separated,
wherein either the first housing or the second housing is provided with either the holder body or the cover, and
wherein the stabilizer electric power line is led to outside of the stabilizer housing through a gap between the first housing and the second housing and is then introduced into the connection space through a coupling gap between the holder body and the cover.

4. The compact discharge lamp according to claim 3,
wherein either the first housing or the second housing is provided with an insertion portion which is inserted into the other side housing so that the first housing overlaps the second housing, and
wherein the stabilizer electric power line led to the outside of the stabilizer housing is pressed and inserted in the overlapping portion of the first housing and the second housing.

5. The compact discharge lamp according to claim 1,
wherein the stabilizer housing and the bulb base are arranged in line,
wherein, out of either one end side, which is a bulb base side, of the stabilizer housing and the other end side, which is the opposite side of the bulb base side, the connection space-forming unit is arranged closer to the bulb base side,
wherein the stabilizer printed circuit board is arranged in an arrangement direction in which the stabilizer housing and the bulb base are arranged, and
wherein relatively heat-vulnerable circuit elements amongst the stabilizer circuit elements are arranged at a position farthest from the bulb base on the stabilizer printed circuit board.

6. The compact discharge lamp according to claim 5,
wherein the heat-vulnerable circuit element is a semiconductor element or an electrolyte capacitor.

7. The compact discharge lamp according to claim 6,
wherein the semiconductor is a transistor, a field effect transistor (FET), or a control IC.

8. The compact discharge lamp according to claim 5,
wherein relatively less heat-sensitive elements from amongst the stabilizer circuit elements are arranged closer to the bulb base on the stabilizer printed circuit board.

9. A discharge lamp, comprising:
a discharge tube equipped with an electrode to be supplied with electric power;
a stabilizer housing; and
a bulb base coupled to an end portion of the stabilizer housing;
a stabilizer printed circuit board that is accommodated in the stabilizer housing and is provided with stabilizer circuit elements configured to initiate a discharge by being supplied with electric power from the bulb base and by supplying the electric power to the electrode and configured to perform driving such that the initiated discharge is maintained;
wherein, out of a bulb base side and the opposite side, the electrode is arranged closer to the bulb base side than the opposite side, and
wherein heat-vulnerable circuit elements out of the stabilizer circuit elements are arranged at a position farthest from the bulb base on the stabilizer printed circuit board.
